(19) United States
(12) Patent Application Publication
(10) Pub. No.: US 2012/0005438 A1
(43) Pub. Date: Jan. 5, 2012

(54) INPUT/OUTPUT CONTROL APPARATUS AND INFORMATION PROCESSING APPARATUS

(75) Inventors: Kiyoshi Miyazaki, Kawasaki (JP); Osamu Watanabe, Kawasaki (JP); Masao Iseki, Kawasaki (JP); Manabu Takahashi, Kawasaki (JP); Takanobu Akiba, Kawasaki (JP)

(73) Assignee: FUJITSU LIMITED, Kawasaki-shi (JP)

(21) Appl. No.: 13/159,235

(22) Filed: Jun. 13, 2011

(30) Foreign Application Priority Data
Jun. 30, 2010 (JP) 2010-149872

(51) Int. Cl. G06F 12/02

(52) U.S. Cl. 711/157; 711/E12.002

(57) ABSTRACT

An apparatus that enables data to be input to and output from a first processing device that performs an arithmetic operation and outputs first data, a second processing device that performs an arithmetic operation and outputs second data that has a number of bits which is smaller than the first data, a first storage device and a second storage device. The apparatus includes a data dividing unit and a storage control unit. The data dividing unit divides the first data output from the first processing device. The storage control unit causes the divided first data to be stored in the first storage device and the second storage device and causes the second data output from the second processing device to be stored in one of the first and second storage devices.

### CROSS-REFERENCE TO RELATED APPLICATIONS

This application is related to and claims priority to Japanese Patent Application No. 2010-149872 filed on Jun. 30, 2010 and herein incorporated by reference.

### BACKGROUND

1. Field

The embodiments discussed herein relate to an input/output control apparatus and an information processing apparatus.

2. Description of the Related Art

A memory access control device that controls input and output of data between a central processing unit (CPU) and a main storage device is known. The memory access control device, the CPU and the main storage device are included in an information processing apparatus.

There is an information processing apparatus that has two CPUs that output data of different numbers of bits to a main storage device (for example, refer to JP-A-4-359335).

### SUMMARY

It is an aspect of the embodiments discussed herein to provide an apparatus that enables data to be input to and output from a first processing device that performs an arithmetic operation and outputs first data, a second processing device that performs an arithmetic operation and outputs second data that has a number of bits which is smaller than the first data, a first storage device and a second storage device.

The apparatus includes a data dividing unit and a storage control unit. The data dividing unit divides the first data output from the first processing device. The storage control unit causes the divided first data to be stored in the first storage device and the second storage device and causes the second data output from the second processing device to be stored in one of the first and second storage devices.

The object and advantages of the invention will be realized and attained by AT LEAST the elements, FEATURES, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of an information processing apparatus.

FIG. 2 is a diagram illustrating an example of an input/output control apparatus.

FIG. 3 is a diagram illustrating an example of a data format of addresses output from arithmetic processing devices.

FIG. 4 is a diagram illustrating an example of relationships between the addresses output from the arithmetic processing devices and addresses of main storage devices.

FIG. 5A is a diagram illustrating an example of storage regions that are included in main storage devices and specified by converted addresses.

FIG. 5B is a diagram illustrating an example of storage regions that are included in the main storage devices and specified by the addresses of the arithmetic processing devices.

### DETAILED DESCRIPTION OF THE EMBODIMENTS

When data that has different numbers of bits is output from a CPU and stored in a main storage device, the main storage device is configured on the basis of the larger number of the bits or configured on the basis of the smaller number of the bits. When the data that has the smaller number of the bits is stored in the main storage device that is configured on the basis of the larger number of the bits, an unused storage region exists in the main storage device.

In addition, when the main storage device is configured on the basis of the smaller number of the bits, a part of the data that has the larger number of the bits cannot be stored in the main storage device. Thus, the CPU that can output the data that has the larger number of the bits generates data so that the result of an arithmetic operation is in a range of the bits that can be stored in the main storage device. Therefore, an operation is limited due to performance of the main storage device.

According to an embodiment, an input/output control apparatus enables data to be input to and output from a first processing device that performs an arithmetic operation and outputs first data; a second processing device that performs an arithmetic operation and outputs second data that has bits of which the number is smaller than the first data; a first storage device; and a second storage device. The input/output control apparatus includes a data dividing unit and a storage control unit.

The data dividing unit divides the first data output from the first processing device.

The storage control unit causes the divided first data to be stored in the first storage device and the second storage device and causes the second data output from the second processing unit to be stored in one of the first and second storage devices.

The input/output control apparatus disclosed herein causes all of a plurality data pieces that have different numbers of bits and are output from the arithmetic processing devices to be stored in the main storage devices and provides an effect to reduce or prevent an unused storage region from existing.

[1. Details of Information Processing Apparatus]

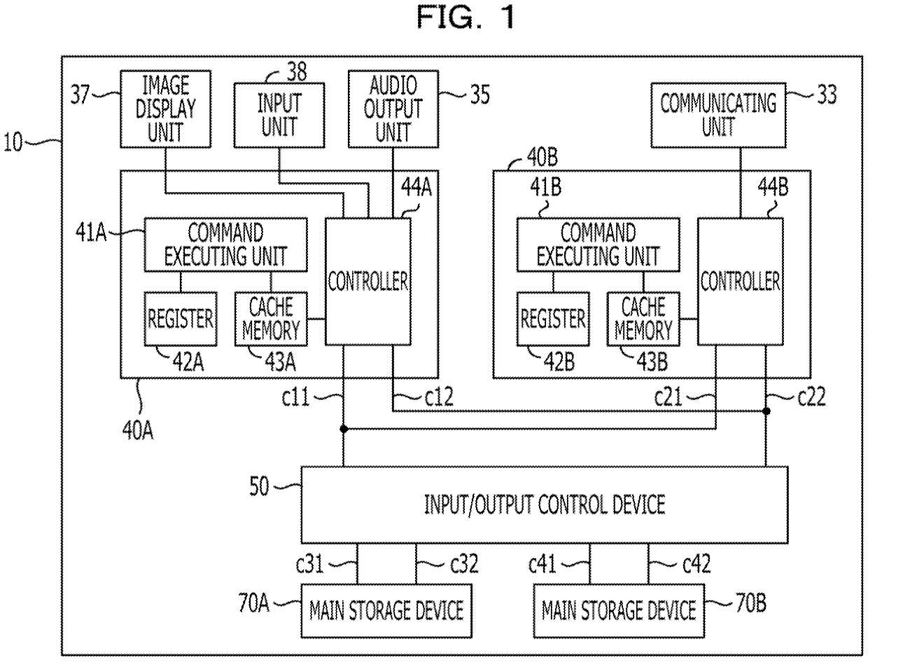

FIG. 1 is a diagram illustrating an example of an information processing apparatus. In FIG. 1, reference numeral 10 indicates an information processing apparatus. As illustrated in FIG. 1, the information processing apparatus 10 includes an arithmetic processing device 40A, an arithmetic processing device 40B, an input/output control device 50, a main storage device 70A and a main storage device 70B. The information processing device 10 also includes a communicating unit 33, an audio output unit 35, an image display unit 37, and an input unit 38. The arithmetic processing devices 40A and 40B receive and output data from and to the main storage devices 70A and 70B through the input/output control device 50. The information processing device 10 is a server, a personal computer or a mobile terminal that is capable of transmitting and receiving data through wireless communication, for example.

[1.1 Arithmetic Processing Devices]

The arithmetic processing device 40A includes a command executing unit 41A, a register 42A, a cache memory 43A and a controller 44A. The arithmetic processing device 40B includes a command executing unit 41B, a register 42B, a cache memory 43B and a controller 44B. The arithmetic processing devices 40A and 40B are CPUs, for example.

An external data bus width that is the number of bits of data to be input to and output from the arithmetic processing device 40A from and to the main storage devices 70A and 70B is larger than an external data bus width of the arithmetic processing device 40B. For example, the external data bus width of the arithmetic processing device 40A is 64 bits, while the external data bus width of the arithmetic processing device 40B is 32 bits. In the following description, it is assumed that the external data bus width of the arithmetic processing device 40A is 64 bits and the external data bus width of the arithmetic processing device 40B is 32 bits. However, the external data bus widths are not limited to the aforementioned numbers of bits.

The arithmetic processing device 40A and the arithmetic processing device 40B access address spaces that are included in the main storage devices 70A and 70B and different from each other. The arithmetic processing devices 40A and 40B generate data so that an address of the data output from the arithmetic processing device 40A is different from an address of the data output from the arithmetic processing device 40B. The addresses that are output from the arithmetic processing devices 40A and 40B are converted into physical addresses of the main storage devices 70A and 70B by the input/output control device 50 in order to reduce or prevent an unused storage region from existing in the main storage devices 70A and 70B.

The command executing unit 41A or 41B of the arithmetic processing device 40A or 40B achieve a specified function by executing a program stored in the main storage device 70A or 70B.

The register 42A or 42B is a storage device that stores: data that is the result of a calculation performed by the command executing unit 41A or 41B; an address to be used to read and write data from and in the main storage device 70A or 70B; an operational state of the command executing unit 41A or 41B; and the like.

A data bus width of the register that stores data is related to an external data bus width of a data signal line c11 or c21 of the arithmetic processing device 40A or 40B. For example, the data bus width of the register of the arithmetic processing device 40A or 40B is substantially equal to the external data bus width.

The cache memories 43A and 43B are storage devices that store data or commands that is or are to be frequently used by the command executing units 41A and 41B among data or commands that is or are stored in the main storage device 70A or 70B.

The controllers 44A and 44B are units that control loading of a command or data into the cache memories 43A and 43B from the main storage device 70A or 70B and storage of data into the main storage device 70A or 70B from the cache memories 43A and 43B.

The controllers 44A and 44B control connections between the command executing units 41A, 41B and other units. For the connections between the command executing unit 41A and the other units, the other units are the image display unit 37, the input unit 38 and the audio output unit 35. For the connection between the command executing unit 41B and the other unit, the other unit is the communicating unit 33.

The controllers 44A and 44B perform operations to connect the arithmetic processing devices 40A and 40B to the other units in accordance with a standard such as Peripheral Component Interconnect Express (PCI Express), for example.

The arithmetic processing device 40A performs an arithmetic operation on an input signal received from the input unit 38. The arithmetic processing device 40A causes an image of the result of the arithmetic operation to be displayed on the image display unit 37 or causes audio data in the result of the arithmetic operation to be output from the audio output unit 35. The image display unit 37 is a liquid crystal display or an organic electroluminescence display, for example. The input unit 38 is a keypad, for example. The audio output unit 35 is a speaker, for example.

The arithmetic processing device 40A converts a digital audio signal in Pulse-Code Modulation (PCM) format into an analog signal and outputs the analog signal to the audio output unit 35, for example. The arithmetic processing device 40A generates, on the basis of an image signal in YUV format or RGB format, a display driving signal to be used to drive the image display unit 37 and supplies the display driving signal to the image display unit 37, for example. The arithmetic processing device 40A receives an operational signal generated by operating the input unit 38 by a user of the information processing apparatus 10 and performs an arithmetic operation on the basis of the operational signal.

The arithmetic processing device 40B is connected to the communicating unit 33 as illustrated in FIG. 1. The communicating unit 33 receives a wireless signal that includes video data or audio data. The communicating unit 33 acquires, from the wireless signal, the video or audio data that is a digital signal. The communicating unit 33 performs baseband processing (such as analog/digital (A/D) conversion, Fourier transform and reverse diffusion) on a radio wave received by a reception antenna (not shown). After that, the communicating unit 33 extracts a radio wave in a specific frequency band. The arithmetic processing device 40B performs an encoding process or a decoding process on the radio wave (received by the communicating unit 33 from the external) in accordance with a wireless access method such as Wideband Code Division Multiple Access (WCDMA), for example.

[1.2 Input/output Control Device]

The input/output control device 50 receives and outputs data from and to the arithmetic processing device 40A or 40B through the data signal line c11 or c21.

The input/output control device 50 receives, from the arithmetic processing device 40A or 40B through an address signal line c12 or c22, an address of data to be read or written.

In an example, the main storage device 70A or 70B cannot store data output from the arithmetic processing device 40A in a bit width for one line. For example, a data bus width of the data output from the arithmetic processing device 40A is 64 bits, while a bit width of data to be stored in a cache line of the main storage device 70A or 70B is 32 bits.

Thus, the input/output control device 50 divides the 64-bit data output from the arithmetic processing device 40A into 32-bit data pieces and causes one of the 32-bit data pieces to be stored in the main storage device 70A and the other of the 32-bit data pieces to be stored in the main storage device 70B.

In addition, the main storage devices 70A and 70B are each capable of storing 32-bit data output from the arithmetic processing device 40B in one line. Thus, the input/output control device 50 causes the 32-bit data output from the arithmetic processing device 40B to be stored in one of the main storage devices 70A or 70B.

The input/output control device 50 receives and outputs data from and to the main storage device 70A or 70B through a data bus signal line c31 or c41 and receives and outputs an address from and to the main storage device 70A or 70B through an address bus signal line c32 or c42.

The input/output control device 50 divides data output from the arithmetic processing device 40A into two data pieces and causes one of the data pieces to be stored in the main storage device 70A and the other of the data pieces to be stored in the main storage device 70B. In addition, the input/output control device 50 causes data output from the arithmetic processing device 40B to be stored in the main storage device 70A or 70B.

[1.3 Main Storage Device]

The main storage devices 70A and 70B are devices that each electronically store data using a semiconductor element. For example, the main storage devices 70A and 70B are dynamic random access memories (DRAMs). As described above, the main storage device 70A or 70B stores data stored in the cache memory 43A or 43B or a command stored in the cache memory 43A or 43B.

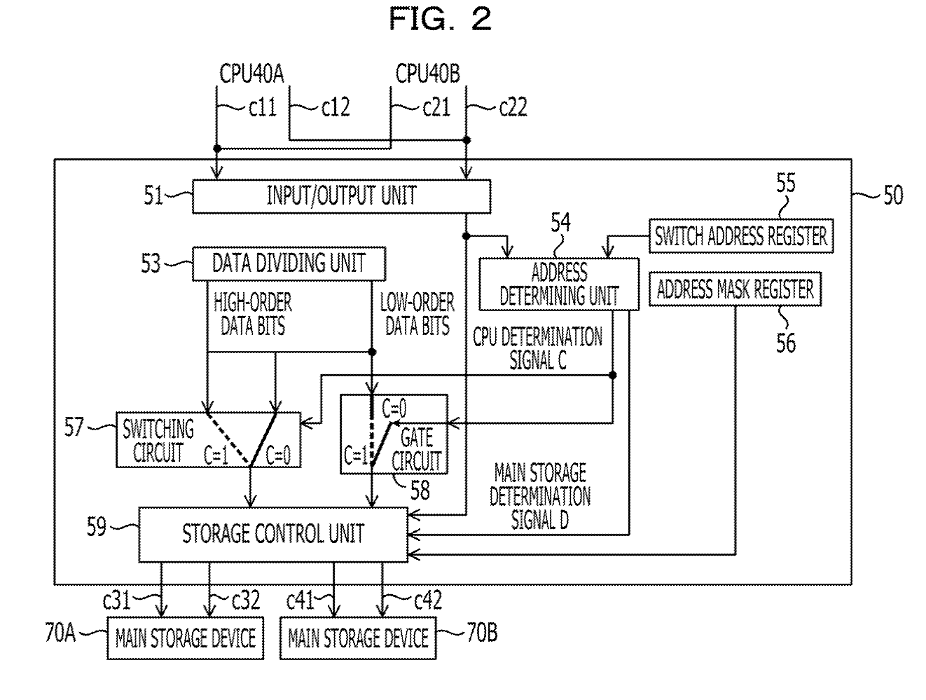

Next, a detailed example of the input/output control device 50 is described with reference to FIGS. 2 to 5B.

[2. Details of Input/output Control Device]

FIG. 2 is a diagram illustrating an example of the input/output control device. The input/output control device 50 includes an input/output unit 51, a data dividing unit 53, an address determining unit 54, a switch address register 55, an address mask register 56, a switching circuit 57, a gate circuit 58 and a storage control unit 59.

[2.1 Input/output Unit]

The input/output unit 51 specifies any of the arithmetic processing devices 40A and 40B and operates as a bus adjusting circuit that permits transfer of data and an address.

The input/output unit 51 receives the data from the data signal line c11 or c21 permitted to transfer the data and receives the address from the address signal line c12 or c22 permitted to transfer the address.

The input/output unit 51 receives and outputs data from and to the arithmetic processing devices 40A and 40B in the data bus width of the arithmetic processing device 40A.

When the data bus width of the arithmetic processing device 40A is 64 bits and the data bus width of the arithmetic processing device 40B is 32 bits, the arithmetic processing device 40B receives and outputs data from and to the input/output unit 51 using low-order 32 bits of the 64 bits.

The input/output unit 51 outputs the data received from the arithmetic processing device 40A or 40B to the data dividing unit 53. The data output from the arithmetic processing device 40B is the low-order bits of the 64 bits, but may be the high-order bits of the 64 bits.

When 64-bit data is transmitted instead of the 32-bit data, it is not necessary that the data lines be prepared for the arithmetic processing devices 40A and 40B, respectively, and the arithmetic processing devices 40A and 40B receive and output data from and to the input/output control device 50 through a common 64-bit data line.

The input/output unit 51 outputs the received address to the address determining unit 54 and the storage control unit 59. The bit width of the address of the arithmetic processing devices 40A is substantially equal to the bit width of the address of the arithmetic processing devices 40B.

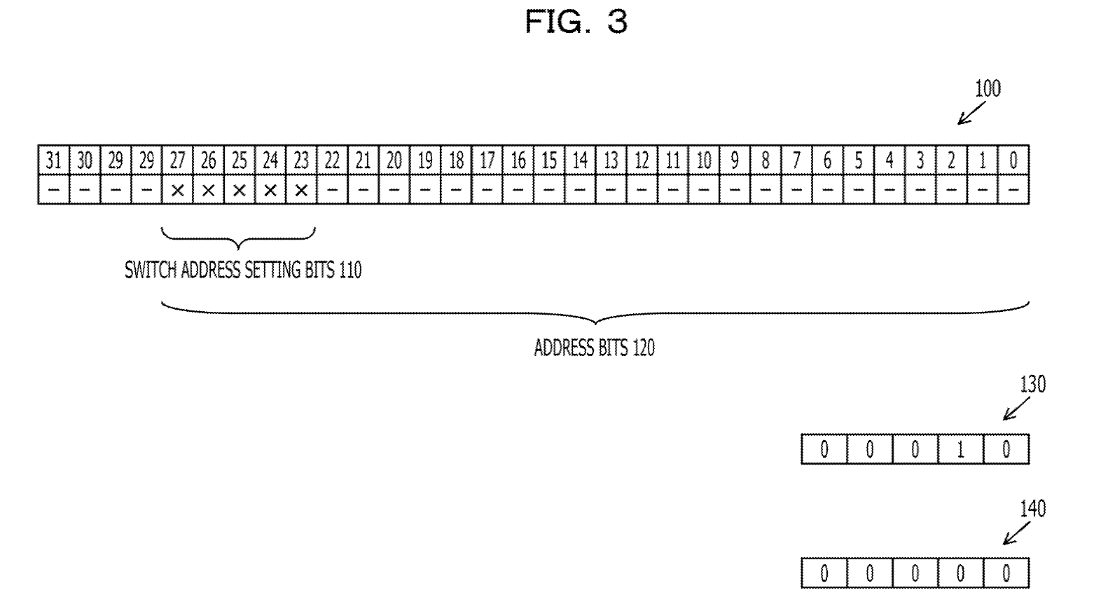

FIG. 3 is a diagram illustrating an example of the addresses. An address 100 is a common format of address data output from the arithmetic processing devices 40A and 40B.

Since storage regions that are included in the main storage devices 70A and 70B and accessed by the arithmetic processing devices 40A and 40B are different from each other, the addresses that are output from the arithmetic processing devices 40A and 40B are different from each other.

The addresses are bit strings of 32 bits (hereinafter represented by “0:31”) indicated by bit numbers of 0 to 31. The 28 bits (0:27) that are indicated by the bit numbers of 0 to 27 of each of the addresses are address bits 120 that specifies the address of the main storage device. The bits (23:27) that are indicated by the bit numbers of 23 to 27 are switch address setting bits 110. The switch address setting bits 110 are a bit string that identifies a device that outputs the address. The switch address setting bits 110 are a bit string of high-order 5 bits of the address bits 120.

[2.2 Data Dividing Unit]

The data dividing unit 53 illustrated in FIG. 2 divides the received data into a high-order bit part and a low-order bit part.

Since the data output from the arithmetic processing device 40A has 64 bits, the data dividing unit 53 outputs the divided high-order 32 bits to the switching circuit 57 and outputs the divided low-order 32 bits to the gate circuit 58.

As described above, the data output from the arithmetic processing device 40B is the low-order 32 bits of the 64 bits.

Thus, the low-order 32 bits are received by the switching circuit 57 and stored in the main storage device 70A or 70B. Therefore, the high-order 32 bits of the 64-bit data that is output from the arithmetic processing device 40B and received from the input/output unit 51 is not used.

[2.3 Switch Address Register and Address Mask Register]

The switch address register 55 is a storage circuit that stores a switch address. The switch address is compared with a bit string of a part of the address output from the arithmetic processing device 40A or 40B and is used to distinguish the data output from the arithmetic processing device 40A from the data output from the arithmetic processing device 40B. As illustrated in FIG. 3, the switch address 130 is a bit string of “00010”, for example.

The address mask register 56 is a storage circuit that stores mask bits. The mask bits are a bit string that is used to generate an address of the main storage device 70A or 70B by masking a part of the address output from the arithmetic processing device 40A or 40B. As illustrated in FIG. 3, the mask bits 140 are a bit string of “00000”, for example.

The storage control unit 59 (described later) performs an AND operation on the switch address setting bits 110 of the address output from the arithmetic processing device 40B using the mask bits 140 and generates a physical address of the main storage device 70A or 70B.

[2.4 Address Determining Unit]

(1) Determination Made by Arithmetic Processing Device that is Outputting Device

When the address determining unit 54 receives the address from the input/output unit 51, the address determining unit 54 outputs a CPU determination signal C and a main storage determination signal D. The CPU determination signal C is used to determine an arithmetic processing device that has output the address, while the main storage determination signal D is used to determine a main storage device that stores the data output from the arithmetic processing device 40B and a storage region of the main storage device.

When the address determining unit 54 compares the switch address setting bits 110 illustrated in FIG. 3 with the switch address 130 illustrated in FIG. 3, and the value of the switch address setting bits 110 is substantially equal to or larger than the value of the switch address 130, the address determining unit 54 determines that a device that outputs the data and the address is the arithmetic processing device 40A. When the address determining unit 54 compares the switch address setting bits 110 with the switch address 130, and the value of the switch address setting bits 110 is smaller than the value of the switch address 130, the address determining unit 54 determines that the device that outputs the data and the address is the arithmetic processing device 40B.

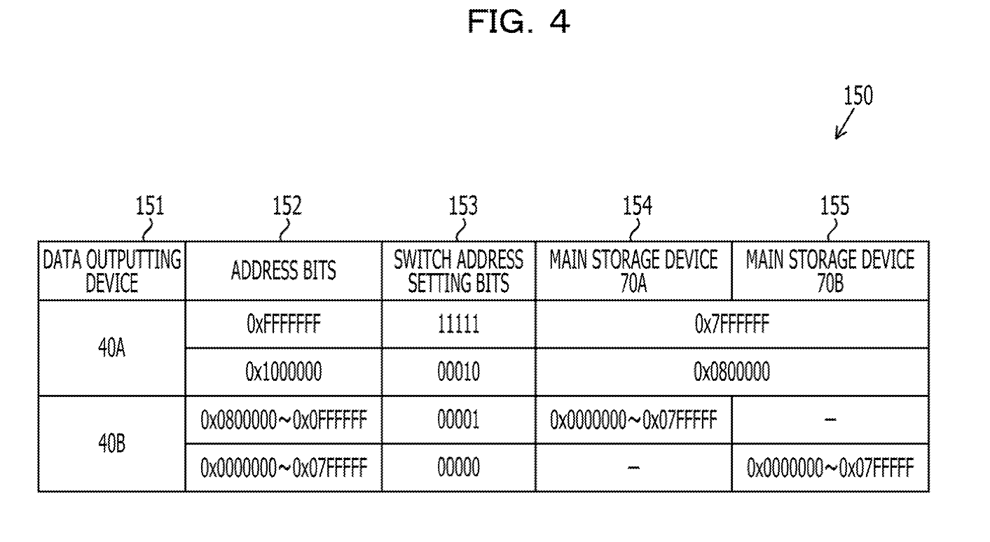

FIG. 4 is a diagram illustrating an example of corresponding relationships between the addresses output from the arithmetic processing devices and the addresses of the main storage devices. A table 150 indicates corresponding relationships among the arithmetic processing devices that output addresses; address bits; switch address setting bits; addresses of the main storage device 70A; and addresses of the main storage device 70B.

In FIG. 4, when a data outputting device (indicated in a column 151) that outputs an address is the arithmetic processing device 40A, address bits 152 are in a range of “0x1000000” to “0xFFFFFFF”.

In addition, when the device that outputs the address is the arithmetic processing device 40B, the address bits 152 are in a range of “0x0000000” to “0x07FFFFF” and in a range of “0x0800000” to “0x0FFFFFF”.

When the address bits output from the arithmetic processing device 40A are a lower limit “0x1000000” as indicated in the column 152, the switch address setting bits that indicate the high-order 5 bits of the address bits are “00010”.

In addition, when the address bits output from the arithmetic processing device 40A are an upper limit “0xFFFFFFF”, the switch address setting bits that indicate the high-order 5 bits of the address bits are “11111”.

Thus, the switch address setting bits of the data output from the arithmetic processing device 40A are in a range of “00010” to “11111”.

When the switch address 130 is “00010” as illustrated in FIG. 3, the value of the switch address setting bits of the data output from the arithmetic processing device 40A is substantially equal to or larger than the value of the switch address 130.

The address determining unit 54 compares the switch address setting bits 110 with the switch address 130, and when the value of the switch address setting bits 110 is substantially equal to or larger than the value of the switch address 130, the address determining unit 54 determines that the device that outputs the address is the arithmetic processing device 40A.

In addition, when the address bits output from the arithmetic processing device 40B are a lower limit “0x0000000” as indicated in the column 152, the switch address setting bits that indicate the high-order bits of the address are “00000” as indicated in the column 153.

In addition, when the address bits output from the arithmetic processing device 40B are an upper limit “0x0800000” as indicated in the column 152, the switch address setting bits that indicate the high-order bits of the address are “00001” as indicated in the column 153. The switch address setting bits of the data output from the arithmetic processing device 40B are in a range of “00000” to “00001”.

When the switch address 130 is “00010” as illustrated in FIG. 3, the value of the switch address setting bits of the data output from the arithmetic processing device 40B is smaller than the value of the switch address 130.

Thus, the address determining unit 54 compares the switch address setting bits 110 with the switch address 130, and when the value of the switch address setting bits 110 is smaller than the value of the switch address 130, the address determining unit 54 determines that the device that outputs the address is the arithmetic processing device 40B.

(2) Determination Made by Arithmetic Processing Device to which Address is Output

The data output from the arithmetic processing device 40B is stored in one of the main storage devices 70A and 70B. The address of the data output from the arithmetic processing device 40B is converted into a physical address by the storage control unit 59 (described later), while the physical address specifies a storage region of one of the main storage devices 70A and 70B.

The address determining unit 54 outputs the main storage determination signal D in response to the received address, while the main determination signal D specifies a main storage device in which the address is stored and a storage region in which the address is stored. The storage control unit 59 converts the address output from the arithmetic processing device 40A or 40B into the physical address of the main storage device 70A or 70B in accordance with the main storage determination signal D.

An example of a method in which a main storage device in which data is stored is identified by the address determining unit 54 using an address output from the arithmetic processing device 40A or 40B is described with reference to FIG. 4.

The switch address setting bits that correspond to the address bits that are in the range of “0x0800000” to “0x0FFFFFF” and output from the arithmetic processing device 40B are “000001” as illustrated in FIG. 4.

In addition, the switch address setting bits that correspond to the address bits that are in the range of “0x1000000” to “0xFFFFFFF” and output from the arithmetic processing device 40A are in a range of “00010” to “11111”.

When the value of the switch address setting bits is substantially equal to or larger than a value of “00001” obtained by dividing the switch address “00010” by 2 and is smaller than the value of “00010”, the address determining unit 54 determines that an outputting device specifies addresses that are in a range of “0x0800000” to “0x0FFFFFF”.

The main storage determination signal D is data that has a bit width of 2 bits, for example.

The address determining unit 54 outputs, to the storage control unit 59, the main storage determination signal D that specifies that the physical addresses of the main storage devices 70A and 70B are in a range of “0x0000000” to “0x07FFFFF”.

When the value of the switch address setting bits is substantially equal to or larger than the value of “00001” obtained by dividing the switch address “00010” by 2 and substantially equal to or larger than the value of “00010”, the address determining unit 54 outputs, to the storage control unit 59, the main storage determination signal D that specifies a physical address of the main storage device 70A.

When the value of the switch address setting bits is not in the aforementioned range or is smaller than the value of “00001” obtained by dividing the switch address “00010” by 2, the address determining unit 54 outputs, to the storage control unit 59, the main storage determination signal D that specifies a physical address of the main storage device 70B.

In this manner, the main storage determination signal D indicates a receiving main storage device and a storage region.

As described later, the storage control unit 59 converts the address output from the arithmetic processing device 40A or 40B into a physical address of the main storage device 70A or 70B in accordance with the main storage determination signal D.

### [2.5 Switching Circuit and Gate Circuit]

When the level of the CPU determination signal C is “1”, the switching circuit 57 outputs, to the storage control unit 59, the high-order data bits output from the data dividing unit 53.

When the level of the CPU determination signal C is “0”, the switching circuit 57 outputs, to the storage control unit 59, the low-order data bits output from the data dividing unit 53.

When the level of the CPU determination signal C is “1”, the gate circuit 58 outputs, to the storage control unit 59, the low-order data bits output from the data dividing unit 53. When the level of the CPU determination signal C is “0”, the gate circuit 58 outputs, to the storage control unit 59, the low-order data bits output from the data dividing unit 53.

The example of FIG. 2 illustrating the switching circuit 57 and the gate circuit 58 indicates that the CPU determination signal C with the level “0” is provided to the switching circuit 57 and the gate circuit 58.

The data output from the arithmetic processing device 40B is provided from the data dividing unit 53 as the low-order data bits. Thus, when the level of the CPU determination signal C is “0”, the data output from the arithmetic processing device 40B is transferred to the storage control unit 59 through the switching circuit 57.

On the other hand, the data output from the arithmetic processing device 40A is divided into the high-order bits and the low-order bits by the data dividing unit 53. The divided high-order bits are provided to the storage control unit 59 through the switching circuit 57, while the divided low-order bits are provided to the storage control unit 59 through the gate circuit 58.

In this manner, the data output from the arithmetic processing device 40A or 40B is provided to the storage control unit 59 without a loss or degradation of the data.

[2.6 Storage Control Unit]

The storage control unit 59 performs a logical operation on the address received from the switching circuit 57 or the gate circuit 58 and converts the address into an address of the main storage device 70A or 70B.

When the storage control unit 59 receives the main storage determination signal D that specifies the main storage devices 70A and 70B, the storage control unit 59 performs a logical shift right operation on the address of the arithmetic processing device 40A to change the address range of “0x1000000” to “0xFFFFFFF” to an address range of “0x0800000” to “0x7FFFFFF”.

When the storage control unit 59 receives the main storage determination signal D that specifies the main storage device 70A, the storage control unit 59 determines that address bits of the address are in a range of “0x0800000” to “0x0FFFFFF”, and the storage control unit 59 performs an AND operation on the switch address setting bits using the address mask “00000”.

Through the AND operation, the storage control unit 59 acquires physical addresses (indicated in the column 154) that are in a range of “0x0000000” to “0x07FFFFF” from the address bits (indicated in the third column of the table illustrated in FIG. 4) that are in a range of “0x0800000” to “0x0FFFFFF”.

In addition, when the storage control unit 59 receives the main storage determination signal D that specifies the main storage device 70B, the storage control unit 59 determines that the addresses are in the range of “0x0000000” to “0x07FFFFF”, and the storage control unit 59 performs an AND operation on the switch address setting bits using the address mask “00000”.

Through the AND operation, the storage control unit 59 acquires the physical addresses (indicated in the column 154) that are in the range of “0x0000000” to “0x07FFFFF” from the address bits (indicated in the fourth column of the table illustrated in FIG. 4) that are in the range of “0x0000000” to “0x07FFFFF”.

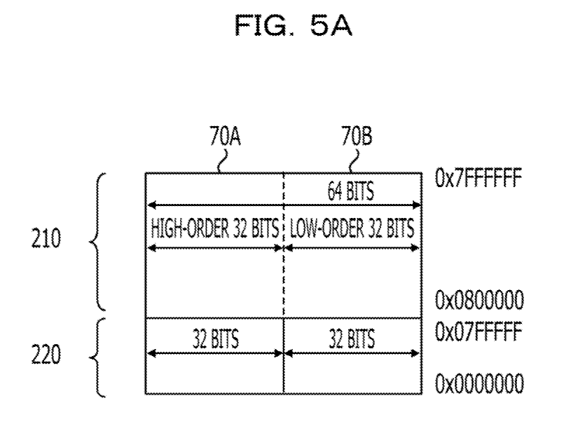

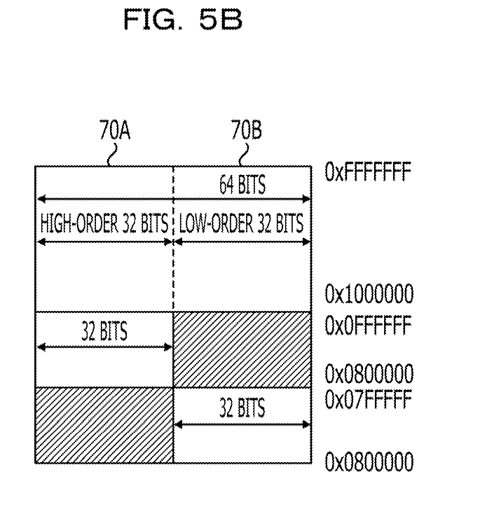

The address conversion reduces or prevents an unused region of the main storage device from existing. This feature is described with reference to FIGS. 5A and 5B.

When the storage control unit 59 receives the main storage determination signal D that specifies the main storage devices 70A and 70B, the storage control unit 59 outputs the high-order data bits received from the switching circuit 57, the low-order data bits received from the gate circuit 58 and the physical addresses to the main storage devices 70A and 70B.

When the storage control unit 59 receives the main storage determination signal D that specifies the main storage device 70A, the storage control unit 59 outputs the data output from the switching circuit 57 and the physical addresses to the main storage device 70A.

When the storage control unit 59 receives the main storage determination signal D that specifies the main storage device 70B, the storage control unit 59 outputs the data output from the switching circuit 57 and the physical addresses to the main storage device 70B.

FIG. 5A is a diagram illustrating an example of storage regions that are included in the main storage devices and specified by the converted addresses.

FIG. 5A illustrates the storage regions of the main storage devices 70A and 70B.

In FIG. 5A, reference numeral 210 indicates storage regions that are included in the main storage devices 70A and 70B and specified by the addresses of “0x0800000” to “0x7FFFFFF”.

The high-order 32 bits of the data output from the arithmetic processing device 40A are stored in the storage region that is included in the main storage device 70A and specified by the addresses of “0x0800000” to “0x7FFFFFF”, while the low-order 32 bits of the data output from the arithmetic processing device 40A are stored in the storage region that is included in the main storage device 70B and specified by the addresses of “0x0800000” to “0x7FFFFFF”.

Reference numeral 220 indicates storage regions that are included in the main storage devices 70A and 70B and specified by the addresses of “0x0000000” to “0x07FFFFF”. The data that is output from the arithmetic processing device 40B and corresponds to the 32 address bits of “0x0800000” to “0x0FFFFFF” are stored in the storage region that is specified by the addresses of “0x0000000” to “0x07FFFFF” and included in the main storage device 70A. In addition, the data that is output from the arithmetic processing device 40B and corresponds to the 32 address bits of “0x0000000” to “0x07FFFFF” are stored in the storage region that is specified by the addresses of “0x0000000” to “0x07FFFFF” and included in the main storage device 70B.

FIG. 5B is a diagram illustrating an example of storage regions that are specified by the addresses of the arithmetic processing devices and included in the main storage devices. FIG. 5B illustrates the storage regions of the main storage devices 70A and 70B. The storage regions of the main storage device 70A or 70B are specified by the addresses indicated in the column 152 (of FIG. 4) in which the address bits are indicated. A storage region (indicated by hatching) that is a space of the addresses of “0x0800000” to “0x0FFFFFF” of the main storage device 70A is not used. A storage region (indicated by hatching) that is a space of the addresses of “0x0000000” to “0x07FFFFF” of the main storage device 70B is not used.

As illustrated in FIG. 5A, the 32-bit main storage devices that each store data of a 32 bit width in one line do not have an unused storage region. In addition, when the two 32-bit main storage devices are used, 64-bit data can be stored in the main storage devices without a loss or degradation of the data.

In addition, when data is stored in the main storage device 70A or 70B without the address conversion, an unused storage region exists in the main storage device 70A or 70B. However, as illustrated in FIG. 5A, the address conversion can reduce or prevent an unused storage region from existing in the main storage devices 70A and 70B.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. An apparatus to enable data to be input to and output from a first processing device to perform an arithmetic operation and outputs first data, a second processing device to perform an arithmetic operation and outputs second data that has a number of bits which is smaller than the first data, a first storage device and a second storage device, comprising:
a data dividing unit to divide the first data output from the first processing device; and
a storage control unit to cause the divided first data to be stored in the first storage device and the second storage device and cause the second data output from the second processing device to be stored in one of the first and second storage devices.

2. The apparatus according to claim 1, wherein the storage control unit converts an address of the second data into an address of the first or second storage device.

3. The apparatus according to claim 1, wherein the storage control unit uses bits included in an address of the first data and bits included in an address of the second data so as to determine a device to which the first data or the second data is output.

4. The apparatus according to claim 1, wherein the data dividing unit determines a high-order bit part or low-order bit part of the received data to be the second data and outputs the determined second data to the storage control unit.

5. An information processing apparatus comprising:
a first processing unit to perform an arithmetic operation and output first data and an address of the first data;
a second processing unit to perform an arithmetic operation and output an address of second data and the second data that has a number of bits which is smaller than the first data;
a first storage device and a second storage device to store the first data and the second data;
a data dividing unit to divide the first data output from the first processing unit; and
a storage control unit to cause the divided first data to be stored in the first storage device and the second storage device and cause the second data output from the second processing unit to be stored in either one of the first and second storage devices.

6. The information processing apparatus according to claim 5, wherein the storage control unit converts an address of the second data into an address of the first or second storage device.

7. The information processing apparatus according to claim 5, wherein the storage control unit uses bits included in the address of the first data and bits included in the address of the second data so as to determine a device to which the first data or the second data is output.

8. The information processing apparatus according to claim 5, wherein the data dividing unit determines a high-order bit part or low-order bit part of the received data to be the second data and outputs the determined second data to the storage control unit.
